(19) United States
(12) Patent Application Publication
(10) Pub. No.: US 2015/0189465 A1
(43) Pub. Date: Jul. 2, 2015

(54) System and Method for Optimizing Battery Power and Data Access Costs During Fetching of Data

(71) Applicants: Michael Siliski, San Francisco, CA (US); Ronghui Zhu, Sunnyvale, CA (US); Thomas G. Nourse, Half Moon Bay, CA (US)

(72) Inventors: Michael Siliski, San Francisco, CA (US); Ronghui Zhu, Sunnyvale, CA (US); Thomas G. Nourse, Half Moon Bay, CA (US)

(73) Assignee: GOOGLE INC., Mountain View, CA (US)

(21) Appl. No.: 13/223,870

(22) Filed: Sep. 1, 2011

(51) Int. Cl. H04W 52/04; H04W 52/02; H04L 29/08; G08C 17/00

(52) U.S. Cl. CPC H04W 4/02; H04W 52/0296; H04L 67/2847

(57) ABSTRACT

A computer-implemented method for optimizing battery power and data access costs during fetching of data in a mobile device is disclosed. The computer-implemented method includes determining whether the mobile device is connected to a station for charging the battery, determining whether the mobile device is receiving a net positive charge, and determining whether the mobile device is in data communication with a server through a cellular network. The computer-implemented method further includes preventing fetching of data in the mobile device when the mobile device is one of: (1) not connected to the station for charging the battery, (2) connected to the station for charging the battery, yet operating in a manner that draws down the battery, (3) in data communication with the server through a cellular network, or (4) not in data communication with the server through an internet connection.

### FIELD OF TECHNOLOGY

The present disclosure relates generally to the conservation of battery power and data access costs in electronic devices, and, more specifically, to a method of optimizing battery power and data access costs during fetching of data in an electronic device.

### BACKGROUND

Digital maps are found in a wide variety of devices, such as car navigation systems, hand-held GPS units, mobile phones, and in many websites. In many of these applications, map data is stored in a number of zoom levels. In one example, there are fourteen zoom levels of map data, and each zoom level has a different number of data tiles. At zoom level 1, for example, there are approximately four tiles or sections of data, and each tile holds the same or a standard amount of geographic data. The data includes the least amount of detail at level 1. In other words, zoom level 1 displays map data of the entire world; as such, the least amount of detail is provided in each data tile. At zoom level 2, and each consecutive zoom level leading up to the most detailed zoom level 14, there are increasingly more tiles and more data and detail for each level.

As a user of an electronic device focuses in on an area of a map within his or her electronic device, a more detailed image of an area of the map is displayed. Thus, to display more detail, the map moves from a lower zoom level to a higher zoom level, e.g., zoom level 2 to zoom level 3, and the electronic device fetches the data stored in the tiles associated with the higher zoom level. While the electronic device is fetching the data, power from the electronic device's battery is being used and data access costs from a service provider, for example, are being incurred. Additionally, because the data is often fetched on-demand, in real-time, and because the amount of data can be substantial, the ability of the device to display the desired map can be delayed, which the user may consider inconvenient.

Accordingly, one solution to alleviate the inconvenience associated with this delay has been for electronic devices to fetch data, such as map data, for example, based on user preferences, a user profile, or other such information. For example, if a user of an electronic device will be travelling outside of his/her residential region, on a vacation or business trip, for example, the electronic device may fetch map data relating to the destination location. As such, the user would immediately be able to access map data on his/her mobile device essentially without delay upon reaching the destination, thus eliminating inconvenient delay that may otherwise be associated with fetching substantial amounts of data in real time.

In such instances, however, the electronic device is fetching data without a user commanding it to do so. Because the user is unaware that any data is being fetched. the user is also unaware that battery power is being used and data access costs are being incurred.

While the foregoing example is explained in the context of mapping services, some other applications track the location of the portable electronic device and send data about local vendors, restaurants, and stores, for example, based on the detected location of the electronic device. Such data is often downloaded to the electronic device without any knowledge to the user about battery power being used and data access costs being incurred. This may also happen when a user is updating a version of an application on his or her electronic device, e.g., mobile phone. In this instance, while the user knows he or she is updating an application to a newer version, the user may not appreciate the amount of battery power and data access costs associated with downloading such new data to the electronic device.

As such, it is desired to assure that fetching operations of the electronic device, many of which are occurring without user oversight, do not negatively affect the battery life of the electronic device and do not incur data costs by performing fetching communications via a cellular network.

### SUMMARY

A computer-implemented method for optimizing battery power and data access costs during fetching of data in a mobile device includes determining whether a mobile device, the mobile device having a battery and a network interface for fetching data through a network, is connected to a station for charging the battery. The method also includes determining whether the battery of the mobile device is receiving a net positive charge from the station for charging the battery and determining whether the mobile device is in data communication with a server through a cellular network. The method additionally includes preventing fetching of data in the mobile device when the mobile device is at least one of: (1) not connected to the station for charging the battery, (2) connected to the station for charging the battery, yet operating in a manner that draws down the battery, (3) in data communication with the server through acellular network, or (4) not in data communication with the server through an internet connection.

The computer-implemented method may further comprise determining a desire to fetch data in the mobile device.

Further, determining whether the mobile device is connected to a station for charging the battery may include receiving a signal from a station for charging the battery, and transmitting data to a processor of the mobile device indicating the signal from the station for charging the battery is received.

Still further, determining whether the battery of the mobile device is receiving a net positive charge may include taking two readings spaced apart in time and comparing the readings to determine whether the battery is increasing in charge.

In addition, determining whether the mobile device is in data communication with a server through acellular network may include the network interface receiving a signal from the cellular network and transmitting data to a processor of the mobile device indicating the receipt of the signal from the cellular network.

In addition, preventing fetching of data in the mobile device may include preventing fetching of data when the mobile device is not connected to the station for charging the battery.

Preventing fetching of data in the mobile device may also include preventing fetching of data when the mobile device is connected to the station for charging the battery, yet operating in a manner that draws down the battery.

Preventing fetching of data in the mobile device may also include preventing fetching of data when the mobile device is in data communication with the server through acellular network.

Preventing fetching of data in the mobile device may also include preventing fetching of data when the mobile device is not in data communication with the server through an internet connection.

Preventing fetching of data in the mobile device may also include preventing fetching of data when the mobile device is not connected to the station for charging the battery and in data communication with the server through a cellular network.

In addition, preventing fetching of data in the mobile device may include preventing fetching of data when the mobile device is connected to the station for charging the battery, yet operating in a manner that draws down the battery and in data communication with the server through a cellular network.

Further, preventing fetching of data in the mobile device may include preventing fetching of data when the mobile device is not connected to the station for charging the battery and not in data communication with the server through an internet connection.

Still further, preventing fetching of data in the mobile device may include preventing fetching of data when the mobile device is connected to the station for charging the battery, yet operating in a manner that draws down the battery and not in data communication with the server through an internet connection.

In another example, a system for optimizing battery power and data access costs during fetching of data includes a mobile device having a processor, at least one memory, a battery, and a network interface for fetching data via a network. The system also includes a module stored within the memory of the mobile device and executable by the processor for preventing fetching of data in the mobile device when the mobile device is at least one of: (1) not connected to the station for charging the battery, (2) connected to the station for charging the battery, yet operating in a manner that draws down the battery, (3) in data communication with a server through a cellular network, or (4) not in data communication with the server through an interne connection.

In yet another example, a computer-readable storage medium includes computer-executable instructions stored thereon and executable by a processor to determine whether a mobile device having a battery and a network interface for fetching data is connected to a station for charging the battery, determine whether the battery of the mobile device is receiving a net positive charge, and determine whether the mobile device is in data communication with a server through a cellular network. The processor of the computer-readable storage medium also prevents fetching of data in the mobile device when the mobile device is at least one of: (1) not connected to the station for charging the battery, (2) connected to the station for charging the battery, yet operating in a manner that draws down the battery, (3) in data communication with the server through acellular network, or (4) not in data communication with the server through an internet connection.

In another example, a system for optimizing battery power and data access costs during fetching of data includes a mobile device having a processor, at least one memory, a battery, and a network interface for fetching data via a network. The system further includes a module stored within the memory and executable by the processor for permitting fetching of data in the mobile device when the mobile device is receiving a net positive charge from a station for charging the battery of the mobile device and is at least one of: (1) not in data communication with the server through a cellular network, or (2) in data communication with the server through an internet connection.

In a still further example, a computer-implemented method for fetching data with a mobile device includes determining a desire to fetch data with a mobile device from a server over a network, the mobile device having a battery and a network interface for fetching the data, and prior to fetching data, determining whether the mobile device is connected to a station for charging the battery, determining whether the battery of the mobile device is receiving a net positive charge from the station for charging the battery, and determining whether the mobile device is in data communication with a server through a cellular network. The method further includes preventing fetching of data when the mobile device is at least one of: (1) not connected to the station for charging the battery, (2) connected to the station for charging the battery, yet operating in a manner that draws down the battery, (3) in data communication with the server through a cellular network, or (4) not in data communication with the server through an internet connection. The method also includes permitting fetching the data when the mobile device is receiving a net positive charge from a station for charging the battery of the mobile device and is at least one of: (1) not in data communication with the server through a cellular network, or (2) in data communication with the server through an internet connection.

### BRIEF DESCRIPTION OF THE DRAWINGS

FIG. 1 is a high-level block diagram of a computing environment that implements a system for optimizing battery and data access costs during fetching of data on a user interface device;

FIG. 2 is a high-level block diagram of a user interface device in accordance with the system of the present disclosure;

FIG. 3 is a high-level block diagram of a user interface device in accordance with the system of the present disclosure, the user interface device connected to a charging station;

FIG. 4 illustrates an example routine or process flow diagram for optimizing battery and data access costs during fetching of data on the user interface device; and

FIG. 5 illustrates another example routine or process flow diagram for optimizing battery and data access costs during fetching of data on the user interface device.

### DETAILED DESCRIPTION

The present disclosure is generally directed to a system and method for optimizing battery and data access costs during fetching of map data in individual mobile devices. The system includes an electronic device, such as a mobile device, that fetches map data and performs battery and data access cost optimization. The system performs such cost optimization by preventing fetching of map data when the mobile device: (1) is not connected to a charging station and thus, a battery of the device is not receiving a positive charge; (2) is connected to a charging station, but operating in a manner that still draws down the battery; and/or (3) is in data communication with the server via a cellular data network. The system may also prevent fetching of map data when the mobile device is not in data communication with the server via a wireless internet connection. These constraints assure that fetching operations of the mobile device, which are occurring without user oversight, do not negatively affect the battery life of the mobile device and do not incur data costs by performing fetching communications via a cellular network.

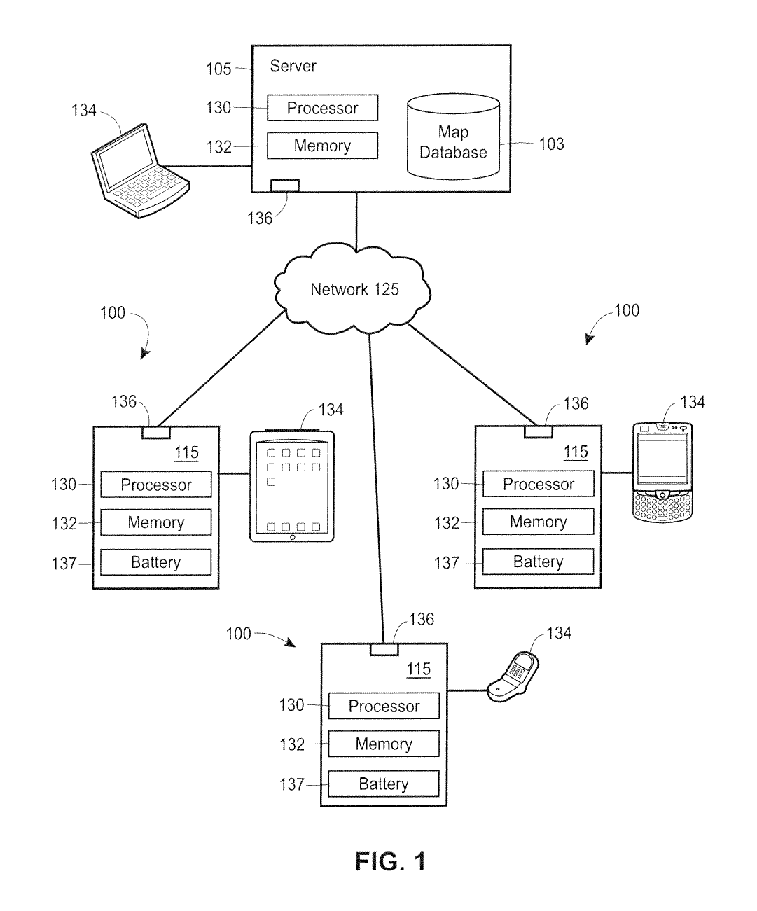

Referring now to FIG. 1, a high-level block diagram illustrating a computing environment for a system 100 for optimizing battery power and data access costs during fetching of data is provided. The computing environment includes a map database 103 connected to or disposed within a server 105 which is, in turn, connected to a plurality of mobile devices 115 through a network 125. The network 125, includes, but is not limited to, any combination of a LAN, a MAN, a WAN, a mobile, a wired or wireless network, a private network, or a virtual private network. While only three mobile devices 115 are illustrated in FIG. 1 to simplify and clarify the description, it is understood that any number of mobile devices 115 are supported and can be in communication with the server 105.

Each of the mobile devices 115 may be connected to or maybe disposed within a user interface device 134. The user interface device 134 may be, for example, a hand-held device, such as a smart phone or tablet computer, a mobile phone, a car navigation system or computer system, or any other device that allows a user to interface with the network 125. Each mobile device 115 includes a processor or CPU 130, one or more computer readable memories 132, and a battery 137 for providing power to the mobile device 115. Each mobile device 115 also includes a network interface 136, one or more peripheral interfaces, and other well known components. While the mobile device 115 includes the network interface 136, a variety of different communication interfaces, such as a wireless personal area network (PAN) transceiver, a wireless local area network (WLAN) transceiver a broadcast radio receiver, an Ethernet port, and a USB port may also be included, depending upon the mobile device 115.

The server 105 is a computer that may also include a CPU 130, one or more computer readable memories 132, one or more user interfaces 134, a network interface 136 and other well-known components. In other examples, other types of computers can be used that have different architectures.

The server 105 and the mobile devices 115 are also adapted to execute computer program modules for providing functionality described therein. As used herein, the terms “module” and “routine” refer to computer program logic used to provide the specified functionality. Thus, a module or routine can be implemented in hardware, firmware, and/or software. In one embodiment, program modules and routines are stored on a storage device, loaded into memory, and executed by a processor or can be provided from computer program products that are stored in tangible computer-readable storage mediums, e.g., RAM, hard disk, optical/magnetic media, etc.

In the present example, the map database 103 contains map data that can be used to generate a digital road map or that can be used by, for example, a navigation system to determine routes between two locations. The map database 103 stores map data of any type, including for example, data pertaining to roads, geographical features, buildings, building models, terrain, satellite images, information regarding businesses, commercial entities, labels, names, and addresses. More generally, in this example, the data stored in the map database 103 may be any data defining a map or geographical area, or defining or related to features or elements shown on a map or within a geographical area.

While the map database 103 is stored in the server 105, the map database 103 does not need to be physically located within the server 105. For example, the database 103 can be placed within the mobile device 115, can be stored in an external storage attached to the server 105, or can be stored in a network attached storage. Additionally, there may be multiple servers 105 that connect to a single database 103. Likewise, the map database 103 may be stored in multiple different or separate physical data storage devices.

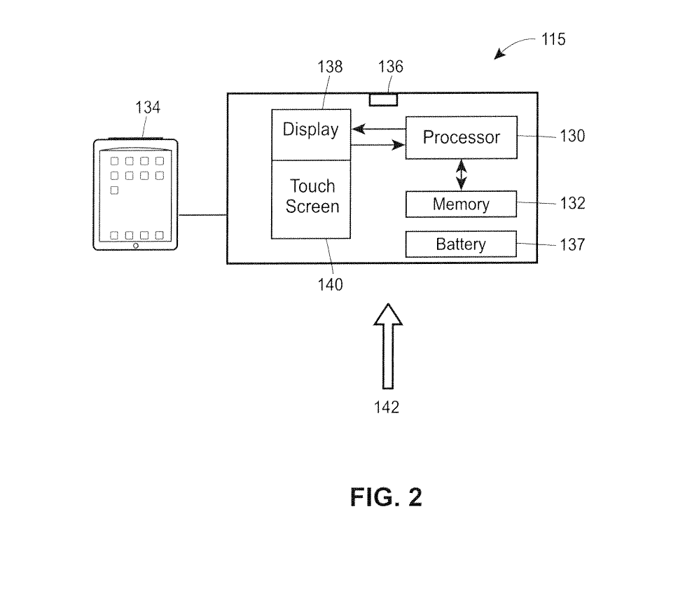

Referring now to FIG. 2, a high-level diagram of one mobile device 115 in accordance with the system 100 of the present disclosure is illustrated. The mobile device 115 includes a CPU 130, one or more computer readable memories 132, a network interface 136, a battery 137, and other well known components. In this example, the mobile device 115 further includes a touch-sensitive display 138 that is covered with a touch-sensitive screen 140 having a grid of electric circuits that sense the approximate location of where a user touches the screen 140 to make an input. Alternatively, the user may use a stylus 142 to contact touch screen 140. The touch screen 140 is electrically connected to the CPU 130, which can compute the location where the user has touched the touch screen 140 to enter an input. In general, the display 138 of the mobile device 115 may include one or more touch-sensitive display panels, and the program instructions residing in memory 132 and executed by CPU 130 may include support for a touch-responsive user interface. The mobile device 115 is further illustrated as connected to or disposed within a user interface device 134, which is a hand-held device, such as a tablet in this illustration.

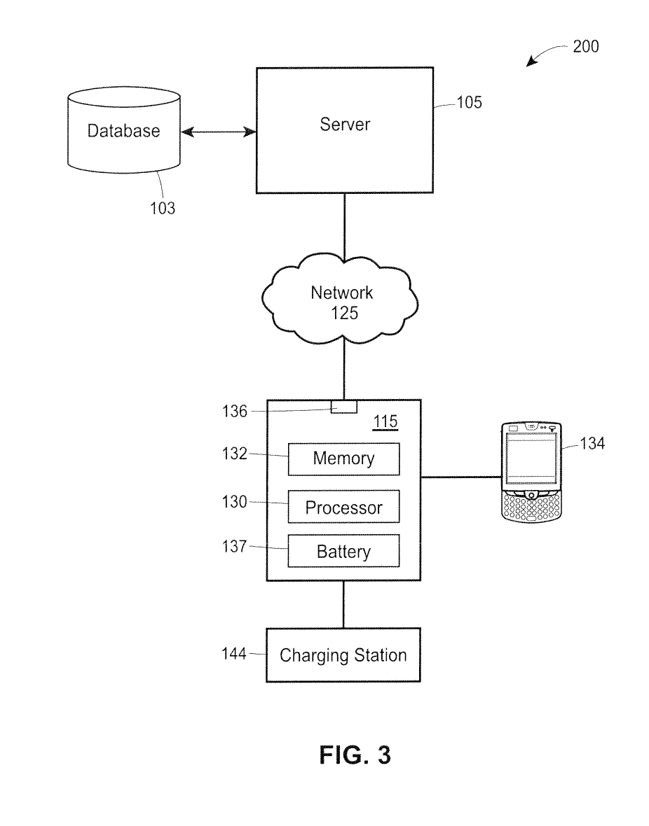

Referring now to FIG. 3, a high-level diagram of another mobile device 115 in accordance with the system of the present disclosure is illustrated. The mobile device 115 of FIG. 3 is illustrated as connected to or disposed within the user interface device 134, which is a smart phone in this example. Here the mobile device 115 also includes a CPU 130, a memory 132, a network interface 136, a battery 137, and other well known components. The user interface device 134 is also connected to a station 144 for charging the battery 137 of the mobile device 115. In this example, the map database 103 is also illustrated as outside of the server 105.

The mobile device 115 may transmit data over the network 125 to the server 105. Such transmission may be, for example, for the purpose of authenticating the mobile device 115 with the server 105, requesting content to be downloaded to the mobile device 115 from the server 105, or the map database 103 connected to or within the server 105, or for some other purpose, depending upon the application. More specifically, the mobile device 115 may request map data from the map database 103 to be downloaded to the mobile device 115. A user of the mobile device 115 may do so when viewing a map on the device 115 and zooming in on the map to see more detail of a particular area. When zooming in, data tiles having more map data must first be downloaded to the mobile device 115 before a user of the mobile device 115 is able to view a more detailed image of the map area. In doing so, the mobile device 115 is fetching map data from the map database 103 of the server 105 through the network 125.

In one example, map data is stored in 14 zoom levels, and each zoom level includes different tiles of map data, with more detail and more data at each consecutively higher zoom level. As a map displayed on the device 115 is blown up or zoomed into, data tiles from the next highest zoom level are fetched from the map database 103 and downloaded to the mobile device 115. To display more detail, the map moves from a lower zoom level to a higher zoom level, e.g., zoom level 2 to zoom level 3, and data stored in data tiles associated with the higher zoom level is downloaded to the mobile device 115, i.e., data is fetching on a mobile device 115. While the mobile device 115 is fetching data from the server 105, power from the mobile device's battery 137 is being used and data access costs from a service provider, for example, are being incurred.

In another example, a user of the mobile device 115 may want to upgrade an existing application, such as commercially available mapping services or applications, on the mobile device 115. To do so, the mobile device 115 must request data from the server 105 before the data having the upgrade is downloaded to the mobile device 115. While the mobile device 115 is fetching upgrade application data in this instance, power from the mobile device's battery 137 is being used and data access costs from a service provider, for example, are again being incurred.

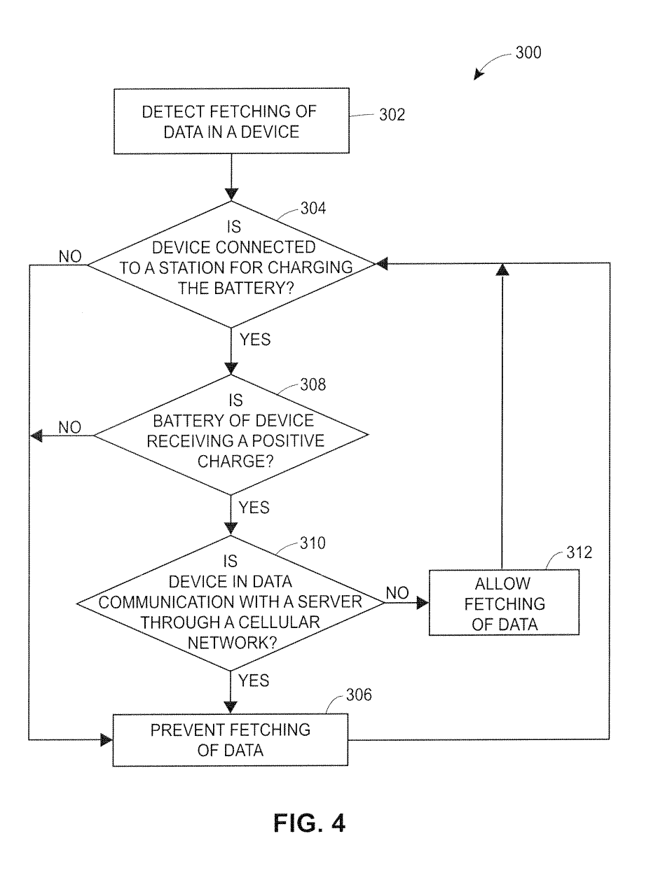

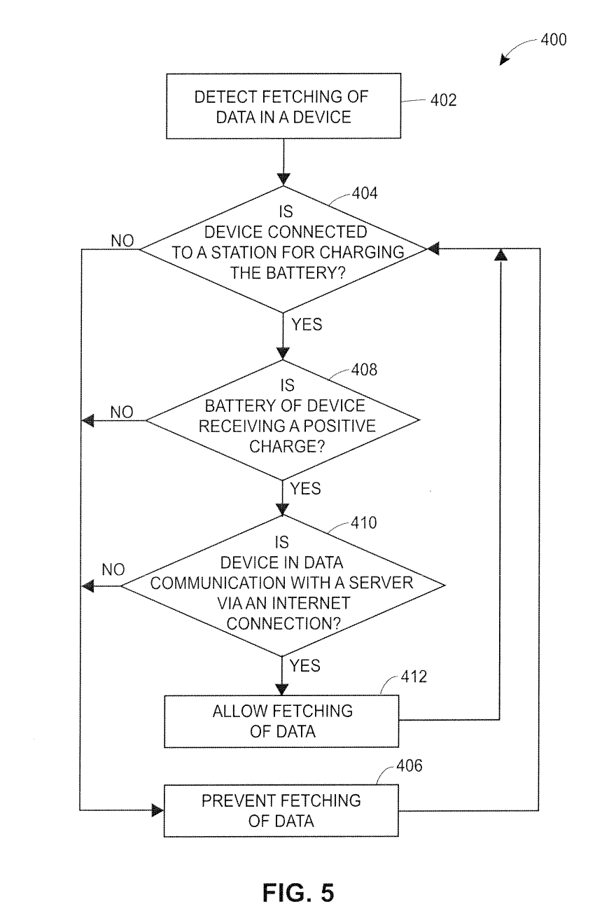

FIG. 4 is a routine or process flow diagram 300 that may be implemented by any of the mobile devices 115 of FIGS. 1, 2 and 3, for example, to optimize battery power and data access costs during fetching of data from the server 105. Generally, the system 300 prevents fetching of data when the mobile device 115: (1) is not connected to the charging station 144 (FIG. 3), (2) is connected to the charging station 144, but is operating in a manner that still draws down the battery 135, and/or (3) is in data communication with the server 105 via a cellular data network 125. The system may also prevent fetching of data when the mobile device 115 is not in data communication with the server 105 through an internet connection, which is explained in more detail below and in FIG. 5.

Initially, as shown in FIG. 4, a module within the mobile device 115 operates to detect fetching of data or to determine a desire to fetch data in the mobile device 115 from the map database 103 (Block 302). After the module detects fetching of data or determines a desire to fetch data in the mobile device 115, the module operates to determine whether the mobile device 115 is connected to the station 144 (FIG. 3) for charging the battery 137 of the mobile device 115 (Block 304). If the mobile device 115 is not connected to the station 144, the module prevents the fetching of data in the mobile device 115 from the map database 103 (Block 306), thereby optimizing the battery of the mobile device 115. If, however, the mobile device 115 is connected to the station 144 for charging the battery 137, then the module determines whether the battery of the mobile device 115 is receiving a positive charge (Block 308). If the battery 137 of the mobile device is not receiving a positive charge, the module prevents fetching of data in the mobile device 115 from the map database 103 of the server 105 (Block 306), again optimizing the battery of the mobile device 115. If the battery 137 is receiving a positive charge, however, the module determines whether the mobile device 115 is in data communication with the server 105 through a cellular network (Block 310). If the mobile device 115 is in data communication with the server 105 through a cellular network, then the module prevents fetching of data on the mobile device 115 from the map database 103 (Block 306), optimizing data access costs for the mobile device 115. If the mobile device 115 is not in data communication with the server through a cellular network, then the module allows fetching of data on the mobile device 115 from the map database 103 of the server 105 through the network 125 to occur (Block 312).

To determine whether the mobile device 115 is connected to a station for charging the battery (Block 304), the processor 130 communicates with the battery 137 of the mobile device 115 and the battery 137 communicates with the charging station 144 (FIG. 3). In one example, the battery may include a sensor that determines whether power is being received from the charging station 144. That sensor transmits a signal to the processor 130 that indicates the battery 137 is receiving power from the charging station 144, and the module then concludes the mobile device 115 is connected to the station for charging the battery.

To determine whether the mobile device 115 is receiving a net positive charge, the processor 130 again communicates with the battery 137 of the mobile device 115 and two readings spaced apart in time are taken to determine if the battery 137 is increasing or decreasing in charge. More specifically, in one example, a first reading includes two pieces of data, the first of which indicates whether the mobile device 115 is connected to the station 144 for charging the battery and charging, and the second of which indicates a current level of the battery 137. A second reading, which is spaced apart in time from the first reading, also includes the two pieces of data: whether the mobile device 115 is connected to the station 144 and charging; and (2) the current level of the battery at this later point in time. The data from the first and second readings are then compared to determine whether the battery 137 is increasing or decreasing in charge.

To determine whether the mobile device 115 is in data communication with the server 105 through a cellular network, the processor or CPU 130 communicates with the network interface 136 (FIGS. 1, 2, 3). More specifically, the network interface 136 may include a sensor that identifies whether the mobile device 115 is in data communication with the server 105 through a network 125. If the mobile device 115 is in data communication with the server through a network 125, the sensor may then determine through what type of network, e.g., cellular network, the mobile device 115 is in data communication with the server 105. In one example, a sensor of the network interface 136 detects a signal from a cellular network and then transmits data to the processor 130 indicating the mobile device 115 is receiving a signal from a cellular network. This allows the module to determine that the mobile device 115 is in data communication with the server through a cellular network. The sensor can also detect and receive a signal from an internet connection, and the sensor then may also transmit data to the processor indicating the network interface 136 is receiving a signal from the internet connection. The module is then able to determine that the mobile device 115 is in data communication with the server through the internet connection.

Referring now to FIG. 5, another routine or process flow diagram 400 is illustrated. The routine process flow diagram 400 may also be implemented by any of the mobile devices 115 of FIGS. 1, 2 and 3, for example, to optimize battery power and data access costs during fetching of data from the server. Initially, and like the module of routine 300 illustrated in FIG. 4, a module within the mobile device 115 operates to detect fetching of data or determine a desire to fetch data in the mobile device 115 from the map database 103 (Block 402). After the module detects fetching of data or determines a desire to fetch data in the mobile device 115, the module operates to determine whether the mobile device 115 is connected to the station 144 (FIG. 3) for charging the mobile device's battery 137 (Block 404). If the mobile device 115 is not connected to the station 144, the module prevents the fetching of data in the mobile device 115 from the map database 103 (Block 406), thereby optimizing the battery of the mobile device 115. If, however, the mobile device 115 is connected to the station 144 for charging the battery 137, then the module determines whether the battery of the mobile device 115 is receiving a positive charge (Block 408). If the battery 137 of the mobile device is not receiving a positive charge, the module prevents fetching of data in the mobile device 115 from the map database 103 of the server 105 (Block 406), again optimizing the battery of the mobile device 115, like the routine 300 illustrated in FIG. 4.

If the battery 137 is receiving a positive charge, however, the module then determines whether the mobile device 115 is in data communication with the server 105 through an internet connection (Block 410). More specifically, and as illustrated in FIG. 5, if the mobile device 115 is not in data communication with the server 105 through an internet connection, then the module prevents fetching of data on the mobile device 115 from the map database 103 (Block 406), optimizing data access costs for the mobile device 115. If, however, the mobile device 115 is in data communication with the server through a cellular network, then the module allows or permits fetching of data on the mobile device 115 from the map database 103 of the server 105 through the network 125 (Block 412).

A computer-implemented method of the present disclosure could include the method of FIG. 4, the method of FIG. 5, or aspects of FIGS. 4 and 5. For example, one computer-implemented method could include the entire method described above with respect to FIG. 4 and could additionally include the determination of whether the mobile device 115 is in data communication with the server via an internet connection (Block 410). As such, in situations where the mobile device is in data communication with the server via both a cellular network and an internet connection, the processor on the mobile device 115 can decide to allow fetching to occur over the internet connection, thereby avoiding data usage costs associated with data transfer over the cellular network.

Moreover, while the methods of FIGS. 4 and 5 have been described as being performed by the mobile device 115, in an alternative version, the methods or processes could be performed by the server 105. That is, the server 105 may receive or extract information from the mobile device 115 indicative of whether the mobile device 115 is connected to a charging station 144, whether the mobile device 115 is receiving a positive charge while connected to the charging station 144, whether the mobile device 115 is in data communication with the server 105 via a cellular network, and/or whether the mobile device 115 is in data communication with the server 105 via an internet connection. Based on this information, the server 105 can then ultimately determine to prevent or enable fetching of data by the mobile device 115 in the same manner as that described above.

Certain embodiments are described herein as including logic or a number of components or modules. Modules may constitute either software modules, e.g., code embodied on a machine-readable medium or in a transmission signal, or hardware modules. A hardware module is a tangible unit capable of performing certain operations and may be configured or arranged in a certain manner. In example embodiments, one or more computer systems, e.g., a standalone, client or server computer system, or one or more hardware modules of a computer system, e.g., a processor or a group of processors, may be configured by software, e.g., an application or application portion, as a hardware module that operates to perform certain operations, as described herein.

In various embodiments, a hardware module may be implemented mechanically or electronically. For example, a hardware module may comprise dedicated circuitry or logic that is permanently configured, e.g., as a special-purpose processor, such as a field programmable gate array (FPGA) or an application-specific integrated circuit (ASIC), to perform certain operations. A hardware module may also comprise programmable logic or circuitry, e.g., as encompassed within a general-purpose processor or other programmable processor, that is temporarily configured by software to perform certain operations. It will be appreciated that the decision to implement a hardware module mechanically, in dedicated and permanently configured circuitry, or in temporarily configured circuitry, e.g., configured by software, or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, e.g., within a home environment, an office environment or as a server farm, while in other embodiments the processors may be distributed across a number of locations.

The performance of certain of the operations may be distributed among the one or more processors, not only residing within a single machine, but deployed across a number of machines. In some example embodiments, the one or more processors or processor-implemented module may be located in a single geographic location, e.g., within a home environment, an office environment, or a server farm.

Unless specifically stated otherwise, discussions herein using words such as “processing,” “computing,” “calculating,” “determining,” “presenting,” “displaying,” or the like may refer to actions or processes of a machine, e.g., a computer, that manipulates or transforms data represented as physical, e.g., electronic, magnetic, or optical, quantities within one or more memories, e.g., volatile memory, non-volatile memory, or a combination thereof, registers, or other machine components that receive, store, transmit, or display information.

One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for optimizing battery power and data access costs during fetching of map data in an electronic device. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

1. A computer-implemented method for optimizing battery power and data access costs during fetching of map data in a mobile device, the method comprising:
determining, by one or more processors and based on information specific to a user operating a mobile device, that map data should be fetched to the mobile device without receiving a command from the user to fetch the map data, wherein the map data is for generating a digital map;
determining, by the one or more processors, whether a mobile device, the mobile device having a battery and a network interface for fetching data through a network, is connected to a station for charging the battery;
determining, by the one or more processors, whether the battery of the mobile device is receiving a net positive charge from the station for charging the battery;
determining, by the one or more processors, whether the mobile device is in data communication with a server through a cellular network to communicate data other than map data; and
permitting, by the one or more processors, fetching of map data from a map database via the network only when the mobile device (1) is connected to the station for charging the battery and (2) is not in communication with the server through the cellular network to communicate data other than map data.

2. The computer-implemented method of claim 1, further comprising determining a desire to fetch data in the mobile device.

3. The computer-implemented method of claim 1, wherein determining whether the mobile device is connected to the station for charging the battery includes receiving a signal from the station for charging the battery, and transmitting data to a processor of the mobile device indicating the mobile device received the signal from the station for charging the battery.

4. The computer-implemented method of claim 1, wherein determining whether the battery is receiving a net positive charge includes taking two readings spaced apart in time and comparing the readings to determine whether the battery is increasing in charge.

5. The computer-implemented method of claim 1, wherein determining whether the mobile device is in data communication with a server through a cellular network includes the network interface receiving a signal from the cellular network and transmitting data to a processor of the mobile device indicating the device is receiving a signal from the cellular network.

6. The computer-implemented method of claim 1, wherein permitting the fetching of map data comprises preventing fetching of data when the mobile device is not connected to the station for charging the battery.

7. The computer-implemented method of claim 1, wherein permitting the fetching of map data comprises preventing fetching of data when the mobile device is connected to the station for charging the battery, yet operating in a manner that draws down the battery.

8. The computer-implemented method of claim 1, wherein permitting the fetching of map data comprises preventing fetching of data when the mobile device is in data communication with the server through a cellular network.

9. The computer-implemented method of claim 1, wherein permitting the fetching of map data comprises preventing fetching of data when the mobile device is not in data communication with the server through an internet connection.

10. The computer-implemented method of claim 1, wherein permitting the fetching of map data comprises preventing fetching of data when the mobile device is not connected to the station for charging the battery and in data communication with the server through a cellular network.

11. The computer-implemented method of claim 1, wherein permitting the fetching of map data preventing fetching of data when the mobile device is connected to the station for charging the battery, yet operating in a manner that draws down the battery and in data communication with the server through a cellular network.

12. The computer-implemented method of claim 1, wherein permitting the fetching of map data comprises preventing fetching of data when the mobile device is not connected to the station for charging the battery and not in data communication with the server through an internet connection.

13. The computer-implemented method of claim 1, wherein permitting the fetching of map data comprises preventing fetching of data when the mobile device is connected to the station for charging the battery, yet operating in a manner that draws down the battery and not in data communication with the server through an internet connection.

14. A system for optimizing battery power and data access costs during fetching of data, the system comprising:
a mobile device having a processor, at least one memory, a battery, and a network interface for fetching data via a network;
a map database having map data accessible to the mobile device via the network; and
a module stored within the memory of the mobile device and executable by the processor to permit fetching of map data from the map database only when (1) the mobile device is connected to a station for charging the battery and (2) is not in communication with a server through the network interface to communicate data other than map data, wherein the map data is for generating a digital map.

15. The system of claim 14, wherein the mobile device is disposed within or connected to a user interface device, and the user interface device may be one or more of a smart phone, a tablet computer, a mobile phone, or a car navigation system.

16. The system of claim 14, wherein the network is one or more of a LAN, a WAN, a mobile, a wired or wireless network, or a private network.

17. The system of claim 14, wherein the server is a computer that includes a processor, one or more computer readable memories, one or more user interfaces, and a network interface.

18. (canceled)

19. (canceled)

20. The system of claim 14, wherein the module is further executable by the processor for determining a desire to fetch data in the mobile device.

21. The system of claim 14, wherein the module is further executable by the processor for determining whether the mobile device is connected to the station for charging the battery.

22. The system of claim 21, wherein the module is further executable by the processor for determining whether the battery of the mobile device is receiving a positive charge.

23. The system of claim 14, wherein the module is further executable by the processor for determining whether the mobile device is in data communication with the server through a cellular network.

24. A non-transitory computer-readable storage medium including computer-executable instructions stored thereon and executable by a processor to:
determine, based on information specific to a user operating a mobile device, that map data should be fetched to the mobile device without receiving a command from the user to fetch the map data, wherein the map data is for generating a digital map;
determine whether a mobile device having a battery and a network interface for fetching data is connected to a station for charging the battery;
determine whether the battery of the mobile device is receiving a net positive charge from the station for charging the battery;
determine whether the mobile device is in data communication with a server through a cellular network to communicate data other than map data; and
permit fetching of map data only when (1) the mobile device is connected to the station for charging the battery and (2) is not in communication with the server through the cellular network to communicate data other than map data.

25. The computer-readable storage medium of claim 24, further comprising computer-executable instructions stored thereon and executable by a processor to determine a desire to fetch data in the mobile device.

26. The computer-readable storage medium of claim 24, further comprising computer-executable instructions stored thereon and executable by a processor to transmit data to a processor of the mobile device indicating the mobile device received the signal from the station for charging the battery.

27. The computer-readable storage medium of claim 24, further comprising computer-executable instructions stored thereon and executable by a processor to take two readings spaced apart in time and compare the readings to determine whether the battery is increasing in charge.

28. The computer-readable storage medium of claim 24, further comprising computer-executable instructions stored thereon and executable by a processor to receive a signal from the cellular network and transmit data to a processor of the mobile device indicating the device is receiving a signal from the cellular network.

29. A system for optimizing battery power and data access costs during fetching of data, the system comprising:
a mobile device having a processor, at least one memory, a battery, and a network interface for fetching data via a network;
a map database having map data accessible to the mobile device via the network; and
a module stored within the memory and executable by the processor for permitting fetching of data in the mobile device from the map database only when the mobile device is receiving a net positive charge from a station for charging the battery of the mobile device and is at least one of: (1) not in data communication with the server through a cellular network to communicate data other than map data, or (2) in data communication with the server through an internet connection to communicate data other than map data, wherein the map data is for generating a digital map.

30. The system of claim 29, wherein the mobile device is disposed within or connected to a user interface device, and the user interface device may be one or more of a smart phone, a tablet computer, a mobile phone, or a car navigation system.

31. The system of claim 29, wherein the network is one or more of a LAN, a WAN, a mobile, a wired or wireless network, or a private network.

32. The system of claim 29, wherein the server is a computer that includes a processor, one or more computer readable memories, one or more user interfaces, and a network interface.

33. (canceled)

34. (canceled)

35. The system of claim 29, wherein the module is further executable by the processor for determining a desire to fetch data in the mobile device.

36. The system of claim 29, wherein the module is further executable by the processor for determining whether the mobile device is receiving a net positive charge from the station for charging the battery.

37. The system of claim 29, wherein the module is further executable by the processor for determining whether the mobile device is not in data communication with the server through the cellular network.

38. The system of claim 29, wherein the module is further executable by the processor for determining whether the mobile device is in data communication with the server through the internet connection.

39. A computer implemented method for fetching data with a mobile device, the method comprising:
determining, by one or more processors, a desire to fetch map data with a mobile device from a server over a network, wherein the map data is for generating a digital map, the mobile device having a battery and a network interface for fetching the data; and
prior to fetching the data:
determining, by the one or more processors, whether the mobile device is connected to a station for charging the battery,
determining, by the one or more processors, whether the battery of the mobile device is receiving a net positive charge from the station for charging the battery,
determining, by the one or more processors, whether the mobile device is in data communication with a server through a cellular network,
preventing, by the one or more processors, fetching of data when the mobile device is at least one of: (1) not connected to the station for charging the battery, (2) connected to the station for charging the battery, yet operating in a manner that draws down the battery, (3) in data communication with the server through a cellular network to communicate data other than map data, or (4) not in data communication with the server through an internet connection, and
permitting, by the one or more processors, fetching of data only when the mobile device is receiving a net positive charge from the station for charging the battery of the mobile device and is at least one of: (1) not in data communication with the server through a cellular network to communicate data other than map data, or (2) in data communication with the server through an internet connection.

40. The computer-implemented method of claim 39, wherein permitting fetching of data in the mobile device comprises permitting fetching of data when the mobile device is receiving a net positive charge from the station for charging the battery of the mobile device and is not in data communication with the server through a cellular network.

41. The computer-implemented method of claim 39, wherein permitting fetching of data in the mobile device comprises permitting fetching of data when the mobile device is receiving a net positive charge from the station for charging the battery of the mobile device and is in data communication with the server through an internet connection.

42. The computer-implemented method of claim 39, wherein permitting fetching of data in the mobile device comprises permitting fetching of data when the mobile device is receiving a net positive charge from the station for charging the battery of the mobile device and is not in data communication with the server through a cellular network and is in data communication with the server through an internet connection.
